(19) United States
(12) Patent Application Publication
(10) Pub. No.: US 2001/0028133 A1
(43) Pub. Date: Oct. 11, 2001

(54) Method of making artificial nail and apparatus making therefor

(76) Inventor: Young Soo Han, Gunpo-City (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/766,395

(22) Filed: Jan. 19, 2001

(30) Foreign Application Priority Data
Feb. 18, 2000 (KR) 7788/2000

(51) Int. Cl. B29C 45/14; B29C 45/16

(52) U.S. Cl. 264/266; 425/112; 425/126.1; 425/129.1

(57) ABSTRACT

Disclosed is a method of making artificial nail, including a printed pattern layer. A film having a transfer portion with a printed pattern is placed between two surfaces forming a cavity with a hole. A fluid resin is injected into the cavity through the hole and contacting the transfer portion. The resin solidifies and integrates with the transfer portion, which forms an artificial portion with the printed pattern. Also disclosed is an apparatus for use in making the artificial nail. The apparatus includes a mold including the two surfaces and a film supplier feeding the film with the transfer portion to the mold.

### FIELD OF THE INVENTION

The present invention relates to an artificial nail having a variety of patterns and designs on its surface and a method for making the artificial nail, particularly to an artificial nail with various colored patterns and designs printed thereon and a method for manufacturing the artificial nail.

### BACKGROUND OF THE INVENTION

Generally, women have painted manicure on their nail surfaces for the purpose of nail cosmetics. However, the painting is very cumbersome, and a certain time is required until the manicure has hardened. Thus, it is not easy to go out immediately following the painting. Further, manicure directly painted on the natural nail may be monotonous, and thus, may be tedious to the user. As a result, it is very troublesome for users to remove the manicure with acetone and to paint a different color or coat of manicure. It also costs users to prepare various colors of the manicure. Furthermore, it is not easy to make the shape of the natural nails molded to users' preference.

In order to overcome the above-mentioned problems, artificial nail having a shape similar to that of natural nail has been developed through an injection molding process. The artificial nail is constructed such that it can be bonded onto the surface of the natural nail by means of adhesives such as double-sided tapes. Surface of the artificial nail has the color of resin material that consists of the nail. Thus, if the artificial nail is to be selectively used as needed, predetermined colors of the manicure should have been already painted on the artificial nail surfaces.

The artificial nail has an advantage in that a variety of the artificial nails can be selectively used and replaced in accordance with the user's preference whenever necessary. However, users' desires for beauty and grace cannot be satisfied with this conventional artificial nail since the nail cannot help being monotonously decorated in case that users personally decorate the artificial nail having the inherent color of the resin material.

Recently, there are high quality artificial nails having complex patterns and designs which are manually painted on the surface of the nails by using a variety of ink colors, in order to satisfy the users' preference.

However, manufacture of the high quality artificial nails is very difficult and time consuming since the complicated patterns and designs should be manually painted onto the surfaces of the artificial nails. Further, manufacturing cost for the artificial nails is expensive since high skill is needed in the manufacture of the artificial nails and mass production of the nails is impossible. Thus, there is a shortcoming in that users' own expense of buying the artificial nails increases.

### SUMMARY OF THE INVENTION

The present invention is to solve the above problems in the prior arts. The object of the invention is to provide artificial nails having various colors of patterns and designs of high esthetic sense on its surface and a method for manufacturing the same in a large quantity and in a short period of time.

To achieve the above object, the present invention provides an artificial nail, comprising a base which is made of thermoplastic resin and is formed with a shape of the natural nail, and a decorative layer formed on the base, wherein the decorative layer comprises a pattern-printed layer 25 and an adhesive layer 26 for bonding the printed layer to the base.

According to an aspect of the invention, a method for manufacturing an artificial nail by filling a cavity, which is defined by dies and has a shape of nail, with a thermoplastic resin and forming the thermoplastic resin into an artificial nail, wherein a transfer part 22, which is formed on a base film 21 and has a pattern printed, is transferred to a surface of the artificial nail base 30a made of the thermoplastic resin during the formation of the artificial nail by placing the transfer part 22 within a cavity 13 before filling the cavity with the thermoplastic resin and then by injection molding the thermoplastic resin, is provided.

It is preferable that the transfer part comprises a parting layer, a protective layer, a printed layer and an adhesive layer which are successively deposited from the base film.

### BRIEF DESCRIPTION OF THE DRAWINGS FIG. 1 is a perspective view showing a state of use of an artificial nail.

FIG. 2 is a cross sectional schematic view of a forming apparatus for manufacturing an artificial nail according to the present invention in a state that dies are separated from each other.

FIG. 3 is a plan view of a movable die, showing an exemplary state of arrangement of cavities in the die of FIG. 2.

FIG. 4 is a plan view showing a state of arrangement of the transfer part formed on the film of FIG. 2.

FIG. 5 is an enlarged sectional view taken along a line A-A in FIG. 4.

FIGS. 6(a), 6(b) and 6(c) show manufacturing process for the artificial nail according to the invention.

FIG. 7 is a sectional view of the artificial nail constructed by the manufacturing method according to the invention.

### DETAILED DESCRIPTION FOR PREFERRED EMBODIMENT

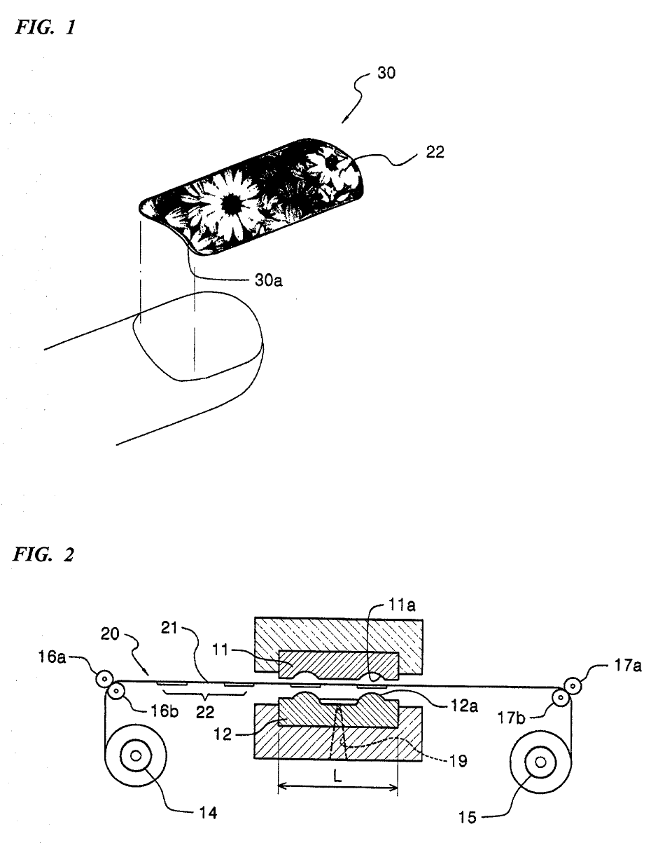

Hereinafter, a method for manufacturing an artificial nail and an artificial nail made by the method according to a preferred embodiment of the present invention will be explained in detail with reference with the accompanying drawings. Referring to FIG. 1, an artificial nail 30 is formed in a manner that a decorative layer 22a with patterns printed is attached to a surface of the artificial nail base 30a. The artificial nail 30 is properly cut in accordance with the shape of the natural nail and is bonded to the natural nail. FIG. 2 schematically shows a construction of a forming apparatus for manufacturing the artificial nail according to the invention. The forming apparatus comprises a fixed die 11 and a movable die 12 corresponding to the injection molds for forming the artificial nail; a feeding roll 14 and a winding roll 15, positioned to the opposite sides of the dies 11, 12, for feeding a transfer film 20 into cavities 13 defined by the dies 11, 12; and guide rolls 16a, 16b, 17a, 17b for guiding conveyance of the transfer film 20.

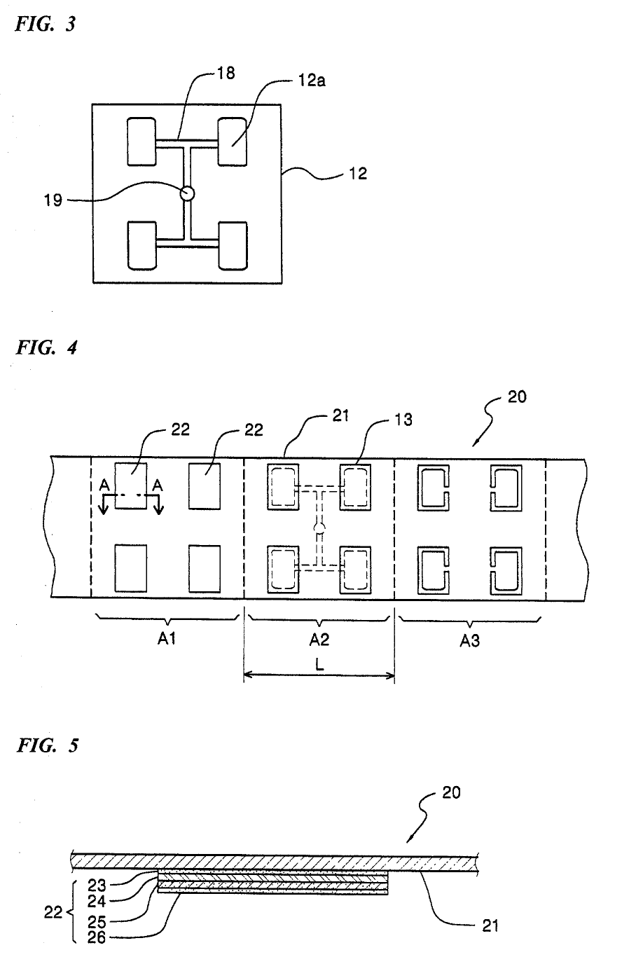

A plurality of grooves 11a having a shape corresponding to the artificial nail is arranged in the fixed die 11. Projecting parts 12a having a height smaller than a depth of the grooves 11a are formed at a position corresponding to the grooves 11a in the movable die 12. The space between the groove 11a of the fixed die 11 and the projecting part 12a of the movable die 12 is defined as one of the cavities 13 for forming the artificial nail. As exemplified in FIG. 3, a plurality of cavities 13 is provided in the dies and communicated with one another through a passage or a runner 18. The runner 18 is communicated with an injection inlet or a spure 19 for injecting the thermoplastic resin into the runner.

As shown in FIG. 4, a transfer film 20 comprises frames A1, A2, A3 by arranging a plurality of transfer parts 22 having designs printed in various colors onto an elongate band-like base film 21. The arrangement of the transfer parts 22 formed in the frame A1, A2, A3 corresponds to that of the cavities 13 defined by the fixed and movable dies 11, 12 for forming the artificial nail. The width (L) of the respective frames A1, A2, A3 is substantially identical to the length (L) of the dies 11, 12. Frames A1, A2, A3 are formed repeatedly with a predetermined spacing. Designs printed on the transfer parts 22 may be patterns in which natural creatures (insect such as a butterfly, flowers, etc.), abstract patterns, or number-figured are sketched. However, the present invention is not limited to any one of these patterns.

A flexible film made of plastic resin, for example, PET material, etc. is used as the base film 21. As shown in FIG. 5, the transfer part 22 disposed on the base film 21 comprises, in sequence, a parting layer 23, a protective layer 24, a pattern-printed layer 25, and an adhesive layer 26. The parting layer 23 is a layer for easily separating a decorative layer 22a, which is a part of the transfer part 22, from the base film 21 after formation of the artificial nail. As described hereafter, the decorative layer 22a comprises the adhesive layer, the pattern-printed layer and the protective layer. In one embodiment, the parting layer can be constructed by applying parting agent to the base film 21. The protective layer 24 is a layer for protecting the pattern-printed layer 25, which is transferred to the artificial nail, from the outside. The printed layer 25 can be formed on the protective layer 24 with various colors of inks by means of conventional printing processes such as gravure printing, silk screen printing, etc. The printed layer is printed in a variety of colors. The adhesive layer 26 is a layer for attaching the transfer part 22 to the thermoplastic resin upon formation of the artificial nail. The adhesive for forming the adhesive layer does not have an adhesion property at a condition of room temperature and room pressure, but has an adhesive property at a condition of injection temperature and pressure. The construction of the transfer film 20 with the transfer parts 22 formed thereon and the material of each layer of the transfer parts 22 are the same as those used in the injection molding process which is generally known as in-mold injection molding process.

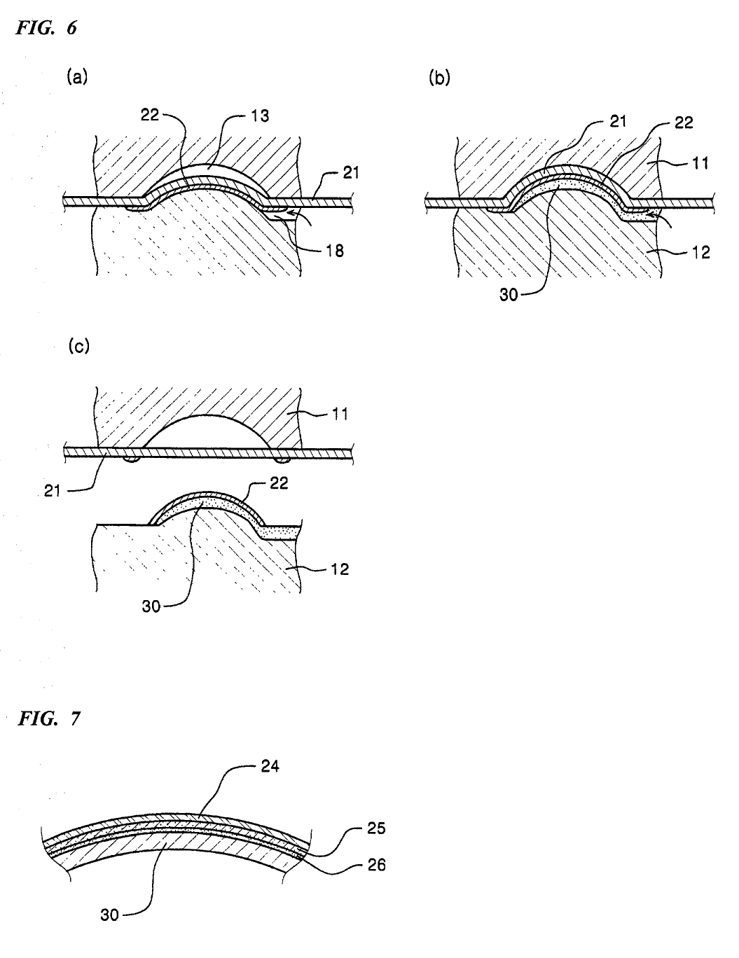

FIGS. 6(a), 6(b) and 6(c) show the manufacturing process of the artificial nail. As shown in FIG. 2, the transfer film 20 wound around the feeding roll 14 is supplied between the fixed die 11 and the movable die 12. The fixed and movable dies 11, 12 are closed after the cavity 13 defined between the dies 11, 12 are correctly positioned with respect to the transfer part 22 within any one frame of the transfer film 20. As shown in FIG. 6(a), the transfer parts 22 are respectively positioned in the cavities 13 and faced correctly with the cavities. Simultaneously, peripheral portions of the transfer parts 22 are pressed and fixed between the fixed die 11 and the movable die 12. In order to correctly position the frames of the transfer film, a guide hole and a guide pin may be formed in the film and the die, respectively. Alternatively, the frame may be correctly positioned by means of a mark printed on the film and a photo sensor mounted to the die.

Next, as shown in FIG. 6(b), fluid phase thermoplastic resin such as ABS resin, etc. is injected through the spure 19 in a predetermined pressure. The cavities 13 are filled with the thermoplastic resin via runner 18 and gate. The resin is formed into the artificial nail base 30a. Simultaneously, the adhesive layer 26 of the transfer parts 22 recovers adhesion capability by means of high temperature and pressure due to injection of the thermoplastic resin, and thus, the transfer parts 22 are attached to the surface of the resin that is formed.

Next, as shown in FIG. 6(c), when the dies are separated from each other, the formed base 30a of the artificial nail 30 with the transfer part 22 of the film 20 attached thereto by means of the adhesive layer 26 is simultaneously separated from the base film 21 at a position of the parting layer 23 between the base film 21 and the protective layer 24. The artificial nail 30 is removed from the movable die 12.

After one cycle of the process for forming the artificial nail is completed as above, rotary driving means, which is not shown, causes the feeding roll 14 and the winding roll 15 to rotate to a degree corresponding to the length L of one frame. By doing so, as shown in frame A3 of FIG. 4, used portion of the base film 21 is wound around the winding roll 15 and the new frame A2 is fed between the two dies 11, 12. Then, the following forming process can be performed consecutively.

According to the manufacturing method, as shown in FIG. 7, the artificial nail 30 which has a decorative layer 22a comprising the adhesive layer 26, the printed layer 25, and the protective layer 24, which are successively disposed on the surface of the artificial nail base 30a, can be made of the thermoplastic resin. Further, mass production of the artificial nail with beautiful patterns printed thereon is possible.

In the foregoing embodiment, when the decorative layer is formed on the surface of the artificial nail 30, it was described that the artificial nail is made by transferring the transfer part 22 to the surface of the artificial nail base 30a made of resin along with injection molding of the artificial nail 30. As another embodiment, the decorative layer may be formed on the surface of the artificial nail 30 by injection molding the artificial nail base with the resin only, taking the base out of the dies, and transferring the transfer film to the base. In a further embodiment, the printed layer is formed by directly printing patterns and designs on the surface of the artificial nail base through a silk screen printing process or directly sketching the pattern and designs on the surface, and the artificial nail is then made by forming the protective layer onto the printed layer.

As in FIG. 1, the artificial nail thus manufactured can be used in a manner that the user cuts the artificial nail into a shape suitable to be fitted with the natural nail, trims the artificial nail, and attaches the artificial nail to the natural nail.

As described above, by implementing the method for manufacturing the artificial nail according to the present invention, high quality artificial nail with various colored patterns printed on its surface can be produced rapidly and in a large quantity without need of high technical skills. Thus, manufacturing cost of the artificial nail can be reduced and high quality artificial nail can be provided inexpensively to the user.

Although the present invention has been described with reference to the above preferred embodiments, it should be understood that any changes or modifications may be made without departing from the scope and spirit of the invention and that the changes or modifications will be within the scope of the present invention which is defined in the claims attached hereto.

What is claimed is:

1. An apparatus for manufacturing an artificial nail, comprising:
a mold comprising two surfaces configured to move relative to each other, wherein when positioned closely the two surfaces define a cavity shaped an artificial nail with a hole adapted to inject a material into the cavity therethrough; and
a film supplier arranged near the mold such that a film supplied by the film supplier is adapted to be placed between the two surfaces and to isolate the two surfaces.

2. The apparatus of claim 1, wherein one of the two surfaces is concave and the other is convex.

3. The apparatus of claim 2, wherein the injection hole is configured such that the material injected through the hole is adapted to contact the convex surface rather than the concave surface when the film is located between the two surfaces.

4. The apparatus of claim 2, wherein the injection hole is configured such that the material injected through the hole is adapted to fill a space formed between the convex surface and the film.

5. The apparatus of claim 1, wherein the film supplier comprises a film feed roll feeding a film to the mold.

6. The apparatus of claim 5, further comprising a take-up roll adapted to receive the film located across the mold from the feed roll.

7. The apparatus of claim 1, wherein the film adapted to be supplied by the film supplier comprises a base film and a transfer portion.

8. The apparatus of claim 7, wherein the transfer portion is formed on a surface of the base film and adapted to be removed from the surface of the base film.

9. The apparatus of claim 8, wherein the transfer portion comprises a printed pattern layer.

10. The apparatus of claim 9, wherein the transfer portion further comprises an adhesive layer.

11. The apparatus of claim 9, wherein the transfer portion further comprises a protective layer.

12. The apparatus of claim 9, wherein the transfer portion further comprises a parting layer contacting the surface of the base film, and wherein the parting layer is adapted to facilitate removal of the transfer portion from the surface of the base film.

13. The apparatus of claim 8, wherein the transfer portion comprises a protective layer, a printed pattern layer and an adhesive layer stacked in order beginning from the base film.

14. The apparatus of claim 1, the mold comprises a plurality of a set of the two surfaces.

15. A method of manufacturing an artificial nail, the method comprising:
providing a mold comprising two surfaces configured to move relative to each other;
placing a film comprising a printed pattern layer between the two surfaces;
moving at least one of the two surfaces toward each other, whereby the two surfaces define a cavity shaped like an artificial nail with a hole, while keeping the film between the two surfaces, wherein the film isolates the two surfaces;
injecting a fluid resin through the hole into the cavity; and
solidifying the resin in the cavity.

16. The method of claim 15, wherein the fluid resin injected into the cavity contacts the film and one of the two surfaces.

17. The method of claim 15, wherein one of the two surfaces is concave and the other is convex.

18. The method of claim 17, wherein the fluid resin injected into the cavity fills a space formed between the convex surface and the film.

19. The method of claim 15, wherein the film comprises a base film and a transfer portion.

20. The method of claim 19, wherein the base film is made of polyethylene terephthalate (PET) resin.

21. The method of claim 19, wherein the transfer portion is formed on a surface of the base film and adapted to be removed from the surface of the base film.

22. The method of claim 19, wherein the transfer portion comprises a printed pattern layer.

23. The method of claim 21, wherein the transfer portion further comprises a layer adapted to contact the resin.

24. The method of claim 23, wherein the layer contacting the resin contains a material having an adhesive property above room temperature.

25. The method of claim 24, wherein the material at a temperature above about 200° C.

26. The method of claim 21, wherein the transfer portion further comprises a protective layer.

27. The method of claim 21, wherein the transfer portion further comprises a parting layer contacting the surface of the base film and wherein the parting layer is adapted to facilitate removal of the transfer portion from the surface of the base film.

28. The method of claim 19, wherein the transfer portion comprises a protective layer, a printed pattern layer and an adhesive layer stacked in order beginning from the base film.

29. The method of claim 15, wherein the fluid resin comprises a thermoplastic resin.

30. The method of claim 29, wherein the thermoplastic resin is selected from the group consisting of acrylonitrile butadiene styrene (ABS), polystyrene (PS), polycarbonate (PC), acrylonitrile styrene (AS), poly (methyl)metracrylate (PMMA), and polypropylene (PP).

31. The method of claim 15, wherein the resin is injected at a temperature from about 200° C. to about 300° C.

32. The method of claim 31, wherein the resin is injected at a temperature from about 220° C. to about 260° C.

33. The method of claim 15, wherein the resin is injected at a pressure from about 500 kg/cm² about 1,200 kg/cm².

34. The method of claim 34, wherein the resin is injected at a pressure from about 800 kg/cm² about 1,000 kg/cm².

35. The method of claim 15, wherein placing the film between the two surfaces comprises feeding the film from a film feed roll.

36. The method of claim 35, wherein the feeding comprises taking up the film with a take-up roll located across the surface from the film feed roll.
